(19) United States
(12) Patent Application Publication
(10) Pub. No.: US 2009/0083923 A1
(43) Pub. Date: Apr. 2, 2009

(54) Multi-purpose hygiene device for back (for massaging, applying lotion or soap)

(76) Inventor: Marcus Klaus Kilian, Little Canada, MN (US)

Correspondence Address: Marcus Kilian, 4533 Churchill Street, Shoreview, MN, 55126, US

(21) Appl. No.: 11/864,171

(22) Filed: Sep. 28, 2007

(51) Int. Cl. A61H 33/00

(52) U.S. Cl. 15/105

(57) ABSTRACT

This multi-purpose hygiene device can be used for washing, applying lotion, and massaging the back. This device is attached to the wall in the bathroom on any smooth surfaces (tiles or plastic surfaces). In order to apply soap or lotion onto the skin of the back, the person needs to use his or her back to move the device if one desires to apply lotion, wash, or massage his or her back. This hygiene device is flexible and can accommodate the individual shape of the back due to its flexibility and elasticity.

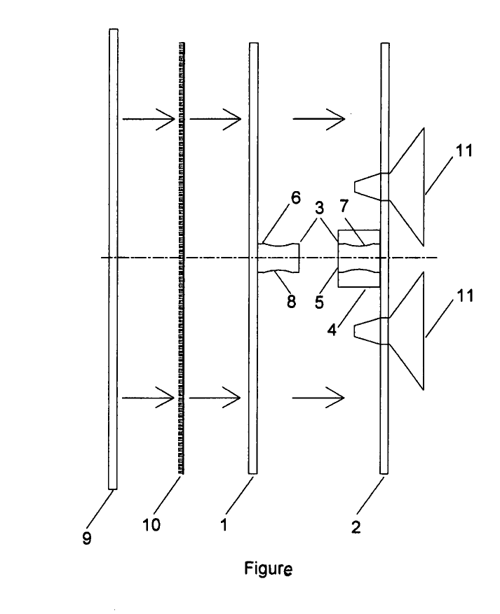

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Body care devices to manipulate the back are common. Often these devices can only be used for massaging the back and cannot be used for applying soap or lotion. In addition, massage devices are not flexible enough to accommodate the individual shape of the back.

### BRIEF DESCRIPTION OF THE INVENTION

This invention is a hygiene device that can be used for washing, applying lotion, and massaging the back. This device is attached to the wall in the bathroom (in the bathtub or shower area) where there are tiles or plastic surfaces. In order to apply soap or lotion onto the skin of the back, the person's back needs to move the surface layer of the device. With this device it is possible to apply lotion or soap to reach areas on the back that are difficult to reach without the help of another person. Once lotion and/or soap has been applied, the felt cloth can be removed and machine-washed for continued use. In addition, this device can be utilized for massaging the back. Unlike similar massage devices, this device is flexible and can accommodate the individual shape of the back. This device is also inexpensive and cost effective.

The objects of the invention are people who live by themselves and are not able to reach their backs to apply lotion or soap.

### BRIEF DESCRIPTION OF THE DRAWING

1. Mounting Plate (1)
2. Base (2)
3. Connection (3)
4. Receiver (4)
5. Opening (5)
6. Pin (6)
7. Convex Curve (7)
8. Concave Curve (8)
9. Surface Layer (9)
10. Velcro Strip (10)
11. Suction Cup (11)

### DETAILED DESCRIPTION OF THE INVENTION

This hygiene device consists of a mounting plate (1), which is attached to the base (2) by means of a flexible connection (3) that can be detached. Attached to the mounting plate (1) is a Velcro strip (10), which is attached to the surface layer (9). The surface layer (9) is used for massaging and washing the back. The base (2) is attached to any smooth surface by means of suction cups (11).

For using this hygiene device it is important that the mounting plate (1) is flexible in conjunction with the base (2) and the wall. The flexible connection (3) consists of a receiver (4), which is permanently attached to the base (2), and a pin (6), which is permanently attached to the mounting plate (1). The receiver (4) has an opening (5) with a square cross-section. The pin (6) also has a square cross-section that perfectly matches the opening (5) so that the pin (6) can slide into the opening (5). Due to the fact that the inner surface of the receiver (4) has a convex curve (7) and the outer surface of the pin (6) has a concave curve (8), the pin (6) can snap into the opening (5), which makes a removable connection between the mounting plate (1) and the base (2) possible. Due to the elasticity of the receiver (4) and the pin (6), the snapping in and removing of the mounting plate (1) from the base (2) have been made easier. Because of the convex curve (7) of the receiver (4) and the concave curve (8) of the pin (6), a tumbling motion of the mounting plate (1) is possible, which enables the surface layer (9) to nestle to the skin of the back.

As mentioned above, the surface layer (9) receives the lotion or soap and is attached to the mounting plate (1) by means of a Velcro strip (10). This enables one to use various materials for the surface layer (9). For example, if one wants to wash one's back, he or she would use felt, if one wants to apply lotion, one would use felt that has been soaked in lotion, etc.

Apparatus of claim 2: hygiene device for washing, applying lotion, and massaging of the back.

### Characterized by:

The removable and flexible connection (3) between the base (2) and the mounting plate (1) is twistable.
Apparatus of claim 3: hygiene device for washing, applying lotion, and massaging of the back.

### Characterized by:

The removable, flexible, and twistable connection (3) consists of a receiver (4) mounted to the base (2) and a pin (6) attached to the mounting plate (1). The receiver (4) has an opening (5) with a square cross-section and the pin (6) also has a square cross-section that matches the opening (5). The inner surface of the receiver (4) has a convex curve (7) and the outer surface of the pin (6) has a concave curve (8).
Apparatus of claim 4: hygiene device for washing, applying lotion, and massaging of the back.

### Characterized by:

The surface layer (9) is attached to the mounting plate (1) by means of a Velcro strip (10).
Apparatus of claim 5: hygiene device for washing, applying lotion, and massaging of the back.

### Characterized by:

The surface layer (9) that receives soap or lotion consists of felt.

1. Hygiene device for washing, applying lotion, and massaging of the back by means of a base attached to a Velcro strip. The base is attached to a mounting plate, which can be detached. The device can be attached to any wall with a smooth surface (e.g., tiles, plastic, etc.), which is in the bathroom.
Wherein the improvement comprises:
The mounting plate (1) is flexibly connected to and removable from the base (2). During the static condition, the mounting plate (1) is parallel to the base (2). The flexible connection (3) enables a tumbling motion during washing, applying of the lotion, and massaging of the back. The surface layer (9), which is used to receive the soap or lotion, is attached to the mounting plate (1) by means of a Velcro strip (10).

2. Hygiene device for washing, applying lotion, and massaging of the back.
Wherein the improvement comprises:
The removable and flexible connection (3) between the base (2) and the mounting plate (1) is twistable.

3. Hygiene device for washing, applying lotion, and massaging of the back.
Wherein the improvement comprises:
The removable, flexible, and twistable connection (3) consists of a receiver (4) mounted to the base (2) and a pin (6) attached to the mounting plate (1). The receiver (4) has an opening (5) with a square cross-section and the pin (6) also has a square cross-section that matches the opening (5). The inner surface of the receiver (4) has a convex curve (7) and the outer surface of the pin (6) has a concave curve (8).

4. Hygiene device for washing, applying lotion, and massaging of the back.
Wherein the improvement comprises:
The surface layer (9) is attached to the mounting plate (1) by means of a Velcro strip (10).

5. Hygiene device for washing, applying lotion, and massaging of the back.
Wherein the improvement comprises:
The surface layer (9) that receives soap or lotion consists of felt.
